(19) United States
(12) Patent Application Publication
(10) Pub. No.: US 2010/0011368 A1
(43) Pub. Date: Jan. 14, 2010

(54) Methods, systems and programs for partitioned storage resources and services in dynamically reorganized storage platforms

(76) Inventors: Hiroshi Arakawa, Sunnyvale, CA (US); Yasunori Kaneda, San Jose, CA (US)

Correspondence Address: MATTINGLY & MALUR, P.C., 1800 DIAGONAL ROAD, SUITE 370, ALEXANDRIA, VA, 22314, US

(21) Appl. No.: 12/216,647

(22) Filed: Jul. 9, 2008

(51) Int. Cl. G06F 9/50; G06F 12/02; G06F 12/16

(52) U.S. Cl. 718/104; 711/170; 711/162; 711/E12.103; 711/E12.002

(57) ABSTRACT

Exemplary embodiments establish durable partitions that are unified across storage systems and storage server computers. The partitions provide independent name spaces and are able to maintain specified services and conditions regardless of operations taking place in other partitions, and regardless of configuration changes in the information system. A management computer manages and assigns resources and functions provided by storage server computers and storage systems to each partition. By using the assigned resources, a partition is able to provide storage and other services to users and applications on host computers. When a configuration change occurs, such as addition or deletion of equipment, the management computer performs reassignment of resources, manages migration of services and/or data, and otherwise maintains the functionality of the partition for the user or application. Additionally, a partition can be migrated within the information system for various purposes, such as improved performance, load balancing, and the like.

### BACKGROUND OF THE INVENTION

According to recent trends, there has been a tremendous increase in the amount of computer equipment making up information systems, such as in data centers, computer systems, and the like. The equipment typically included in such information systems, including switches and storage systems, may be added to the information systems in an on-demand basis or on short notice, while generally, older equipment in the information systems is often removed and used for other purposes or discarded. Thus, the equipment in an information system typically has a limited lifecycle. However, as the amount of equipment in these information systems increases, it has become more difficult for administrators to manage the multitude of equipment, while also meeting the requirements of various users of the information systems, even when conventional management technologies such as CMDB (configuration management database) are employed for managing the equipment in the information systems.

Furthermore, it has become advantageous for the resources of information systems to be implemented in a logically-partitioned manner for the users and applications using the information systems, so that the equipment in the information systems can be used more efficiently. For example, ideally, a logically-partitioned information system is able to provide independent name spaces or ID spaces for users and/or applications. Thus, availability of names or identifiers (IDs), storage areas, data, objects, processes, functions and resources in a logical partition should be able to be handled and managed to operate independently of each other, regardless of the usage or operations taking place in other partitions in the information system. For example, logical partitions in the information system should provide services and engaged quality of the services regardless of the services provided to the other partitions. Additionally, a partition should dynamically provide or modify services, engaged quality of the services, and engaged conditions of resources, regardless of other changes taking place in the information system's configuration. However, conventional management technologies used in information systems are unable to provide effective partitioning in a dynamic and flexible cloud of computing resources in which, as various equipment and resources in the information system are replaced, there is no noticeable effect on the users of the numerous partitions in the data system.

Related art includes U.S. Pat. No. 7,222,172 to Arakawa et al., entitled “Storage System Having Virtualized Resource”; US Pat. Appl. Pub. No. 2006/0010169, to M. Kitamura, entitled “Hierarchical Storage Management System”; and IBM Redbook entitled “IBM System Storage DS8000 Series: Architecture and Implementation”, fourth edition, April 2008, the entire disclosures of which are incorporated herein by reference.

### BRIEF SUMMARY OF THE INVENTION

Exemplary embodiments of the invention provide for partitioned z storage resources and services in an information system whereby the information system can be used in a partitioned manner by users and applications regardless of changes that take place in the configuration of the information system, such as addition, removal or replacement of equipment, or changes in the information system configuration. These and other features and advantages of the present invention will become apparent to those of ordinary skill in the art in view of the following detailed description of the preferred embodiments.

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated.

FIG. 1 illustrates an example of a hardware and logical configuration in which the method and apparatus of the invention may be applied.

FIG. 2 illustrates an example of a configuration of a storage platform.

FIG. 3 illustrates an example of partitioning of services and resources in the storage platform.

FIG. 4 illustrates an exemplary hardware and logical configuration of a storage server computer.

FIG. 5 illustrates an exemplary hardware and logical configuration of a management computer.

FIG. 6 illustrates an exemplary hardware and logical configuration of a storage system.

FIG. 7 illustrates an exemplary logical configuration of a storage system memory.

FIG. 8 illustrates an exemplary process for generating a partition.

FIG. 9 illustrates an exemplary process for deleting a partition.

FIG. 10 illustrates an exemplary process for responding to a service request.

FIG. 11 illustrates an exemplary process for responding to a request to stop service.

FIG. 12 illustrates an exemplary process for responding to deletion or addition of resources.

FIGS. 13A-13B illustrate an exemplary process for migration of services.

FIG. 14A-14B illustrate an exemplary process for migration of data.

FIG. 15 illustrates a conceptual diagram of how each service manages data in partition.

FIG. 16 illustrates a conceptual diagram of an example of the relationship between partitions and changes of the information system configuration.

FIG. 17 illustrates a conceptual diagram of an example of movability of partitions and relocation of partitions.

FIG. 18 illustrates a conceptual diagram of an example of movability of partitions and relocation of partitions when the host is included as part of the partition.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment”, “this embodiment”, or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing”, “computing”, “calculating”, “determining”, “displaying”, or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other types of media suitable for storing electronic information, and may be accessible locally, via a network or other communications media, or both. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for partitioning resources in an information system. In some embodiments, the disclosed computer information system comprises host computers, switches, storage servers, storage systems and management computers. For example, the management computers manage and assign resources provided by storage servers, storage systems and switches to each partition. The resources of the information system include functions provided by storage systems and switches. By using assigned resources, the partition provides storage services to the host computer and applications running on the host computer. When a configuration change takes place in the information system, such as addition or removal of equipment, the management computers perform reassignment of partition resources, manage migration of services and/or data, and otherwise maintain the allotted partitions for the users and/or applications. Also, in addition to managing services and quality of the services in the partitions, engaged conditions regarding the resources are also maintained. Moreover, for relocation of a partition in the information system, the above principles of the partition are maintained.

Exemplary System Configuration

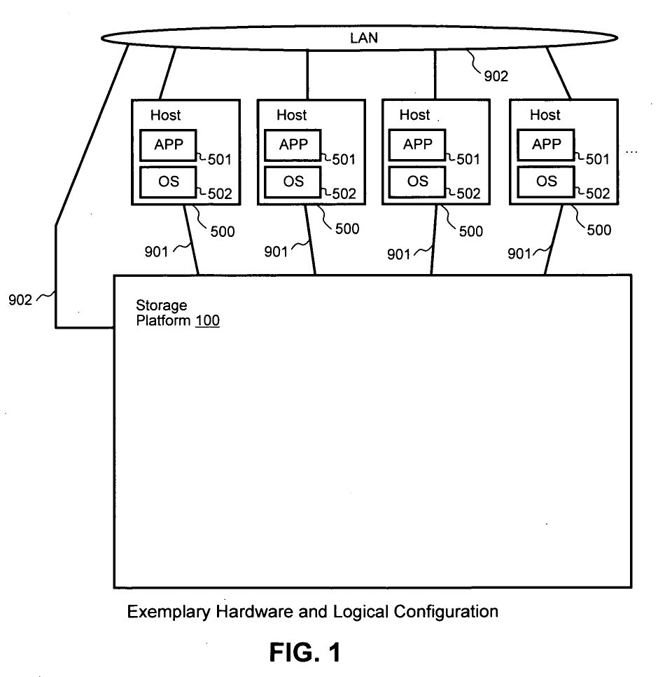

According to exemplary embodiments, FIG. 1 illustrates an example of a hardware and logical configuration of an information system in which the methods and systems of the invention may be implemented. The information system illustrated in FIG. 1 includes a storage platform 100 in communication with one or more host computers 500. Each host computer 500 may include an application (APP) 501 and an operating system (OS) 502 running thereon. Each host 500 can be a conventional computer, workstation, or the like, having typical resources such as a processor, memory, storage and one or more network interfaces (not shown in FIG. 1). Host computers 500 and storage platform 100 may be connected for communication via a storage area network (SAN) 901 (e.g. Fibre Channel, SATA, SAS, iSCSI (IP), FCOE, or the like). Furthermore, host computers 500 and storage platform 100 may be connected for communication via a local area network (LAN) 902 (e.g., an IP network or the like).

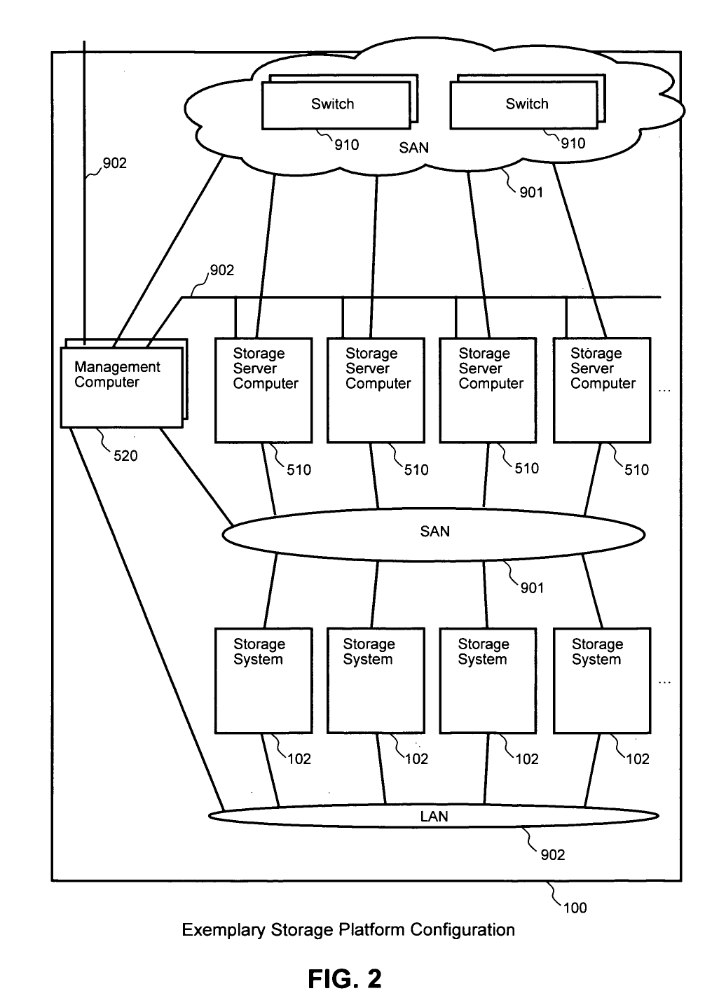

FIG. 2 illustrates an exemplary configuration of storage platform 100. The storage platform 100 may include a number of physical components, including one or more SAN switches 910 for enabling SAN 901, one or more storage server computers 510 for providing server services to host computers 500, one or more management computers 520 for managing partitioning of the storage platform 100 and for carrying out other management functions, and one or more storage systems 102 for storing data used by host computers 500 and the like. Storage servers 510, management computers 520 and storage systems 102 are connected for communication with each other and host computers 500 via SAN 901. Furthermore, storage servers 510, management computers 520 and storage systems 102 may also be connected for communication with each other and host computers 500 via LAN 902. Switches 910 are included in SAN 901 and provide front end interfaces (e.g., ports) with which host computers 500 communicate. Switches 910 may also provide various networking functions such as zoning, virtual SANs, bandwidth guarantee and other quality of service (QoS) control. Detailed configurations of storage server computers 510, management computers 520 and storage systems 102 are described additionally below.

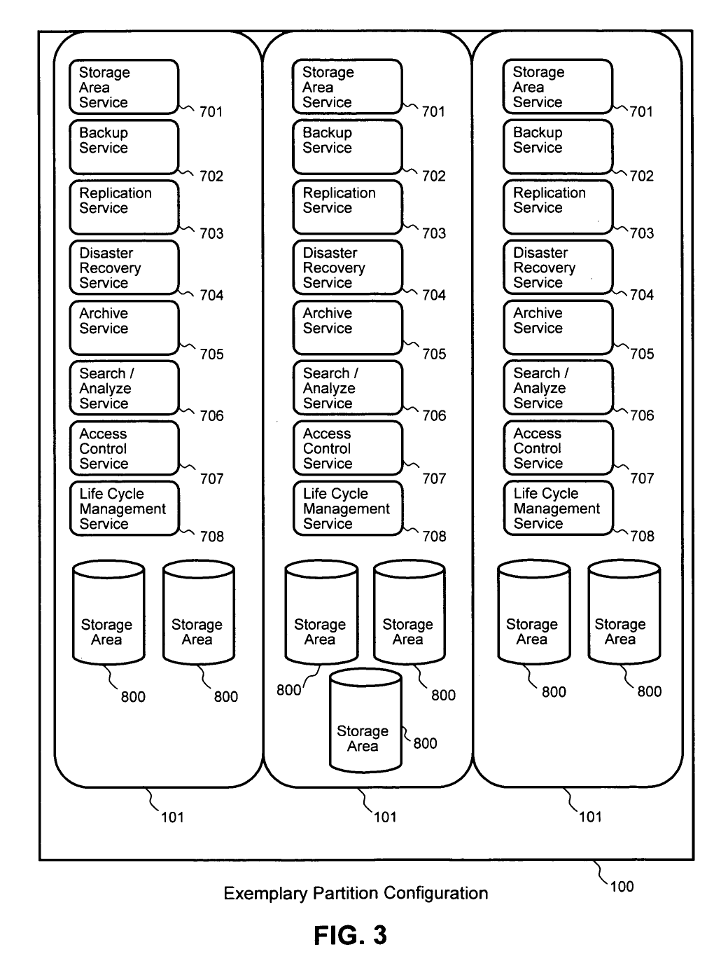

FIG. 3 illustrates an example of a logical configuration of storage platform 100 when the resources of storage platform 100 are partitioned. In the example of FIG. 3, the resources in the storage platform 100 are unified beyond each component and partitioned into a plurality of durable partitions 101, which are not affected by operations taking place in other partitions 101, which are able to withstand changes in the configuration of the information system, and which may be individually used by one or more host computers 500, applications 501 and/or users.

As illustrated in FIG. 3, a logical partition 101 according to exemplary embodiments of the invention may include features such as that each partition 101 may provide an independent name space or ID space for users, applications, etc. The availability of a name or ID of storage area data, objects, processes, functions and resources can be handled according to the individual partition 101 regardless of the usage of other partitions 101. Further, each partition 101 may provide services and engaged quality of the services regardless of the services provided by other partitions 101. Also, a partition 101 may provide services, engaged quality of the services, and engaged conditions about resources regardless of changes in the configuration of the information system.

As illustrated in FIG. 3, each partition 101 provides storage-related services 701-708 and storage areas 800 able to be accessed by host computers 500, or the like. The services provided within a partition may include a storage area service 701, which manages and provides one or more storage areas 800 for storing store user data or other for purposes.

Storage area service 701 may be provided according to exemplary embodiments of the invention for providing an independent name space or ID space to a partition 101 regardless of the existence of other partitions 101. The availability of the name or ID of a storage area, data, objects, process, function and resources of a partition can be handled according to exemplary embodiments of the invention regardless of the usage of other partitions. Also, clients, such as hosts 500, applications, users, or the like, can be able to specify the quality of the storage area within the partition 101, such as guaranteed performance, or the like. For example, clients of this service can specify attributes such as location of a storage area 800, for example, disk type (e.g. FC disk, SAS disk, SATA disk, Flash memory, etc.), actual location (e.g. at a separated area from a failure event perspective, at a separate storage system from original data or at a remote site, etc.) and methods used for ensuring reliability or availability (e.g. mirroring (RAID1), RAID5, distributed storing of data, and the like).

Backup service 702 may be provided according to exemplary embodiments of the invention for enabling backup and/or recovery operations and backup data for data stored in the partition 101. For example, backup service 702 may provide various backup and recovery methods, such as full backup, incremental backup, differential backup, backup to disk, backup to tape, local replication, remote replication, and CDP (continuous data protection). Backup service 702 may use storage area service 701 or replication service 703 for some of these features. Using backup service 702, clients are able to recall backup data to recovery data since this service manages information regarding backup data (i.e., cataloging). Clients of backup service 702 can specify a schedule for carrying out backup operations. In addition, clients of backup service 702 can specify attributes regarding the location at which the backup data is stored, such as disk type (e.g., FC disk, SAS disk, SATA disk, Flash memory, or the like), actual location (e.g., at a separated area from a failure event perspective, at a separate storage system from original data or at a remote site, etc.) and methods for ensuring reliability and availability (e.g., mirroring (RAID1), RAID5, distributed storing of data, or the like).

Replication service 703 may be provided according to exemplary embodiments of the invention for managing and enabling replication of data for various purposes, such as achieving availability, increasing performance (load balancing) and data mining or OLAP (Online Analytical Processing). Replication service 703 provides various replication methods such as file (or object) replication and volume replication; full replication and logical replication (e.g., copy-on-write or snapshot); and local replication and remote replication. Replication service 703 may use storage area service 701 for carrying out some features. Using replication service 703, clients are able to recall replica data since this service manages the information regarding replicas. In addition, clients of replication service 703 can specify attributes regarding the location at which the replicated data is stored, such as disk type (e.g., FC disk, SAS disk, SATA disk, Flash memory, or the like), actual location (e.g., at a separated area from a failure event perspective, at a separate storage system from original data or at a remote site, etc.) and methods for reliability and availability (e.g., mirroring (RAID1), RAID5, distributed storing of data, or the like).

Disaster recovery service 704 may be provided according to exemplary embodiments of the invention to for managing and providing disaster recovery operations and replication for disaster recovery capability. Disaster recovery service 704 provides various methods, such as server-based copying, storage-system-based copying and switch-based copying; synchronous remote copying and asynchronous remote copying; file (or object) copying and volume copying; and conventional remote copy and remote CDP (continuous data protection). Disaster recovery service 704 may use storage area service 701 or replication service 703 for carrying out some features. Using disaster recovery service 704, clients can use secondary data, since this service manages information regarding copy relations and secondary data. Clients of disaster recovery service 704 can also specify expected (or required) performance of the secondary system. In addition, clients of disaster recovery service 704 can specify attributes regarding the location at which the replicated data is stored, such as disk type (e.g., FC disk, SAS disk, SATA disk, Flash memory, or the like) and methods for reliability and availability (e.g., mirroring (RAID1), RAID5, distributed storing of data, and the like).

Archive service 705 may be provided according to exemplary embodiments of the invention for managing and providing archiving operations and archive data for the data stored in a partition 101. Archive service 705 may use storage area service 701 for some features. Clients of archive service 705 can specify schedule (conditions) for archiving data, retention policies regarding protection against modification of archived data, and the like. Clients can also order shredding of the data after expiration of the retention period. Furthermore, clients of archive service 705 can specify metadata stored for each archived data. In addition, clients of archive service 705 can specify various attributes, such as the location at which the backup data is stored, for example, disk type (e.g., FC disk, SAS disk, SATA disk, Flash memory, and the like), actual location (e.g., at a separated area from a failure event perspective, at a separate storage system from original data or at a remote site, etc.) and methods for reliability and availability (e.g., mirroring (RAID1), RAID5, distributed storing of data, and the like).

Search/analyze service 706 may be provided according to exemplary embodiments of the invention for enabling search capabilities for searching data stored in a partition 101, especially, for example, archived data and backup data. For example, by specifying a search key such as a keyword or value stored in metadata, clients of search/analyze service 706 can obtain the results of a search regarding the data in one of partitions 101. Search/analyze service 706 also provides results of analysis regarding the data stored in the partition 101 by specifying conditions and/or logic used to analyze the data.

Access control service 707 may be provided according to embodiments of the invention for enabling access control capabilities for maintaining security regarding the data stored in one of partitions 101. To realize this, various technologies such as authorization, LUN masking, zoning, FC-SP (Fibre Channel-Security Protocol), VLAN (virtual LAN) and IP security can be used. In other words, such functions available in various equipments can be used for access control service 707. Access control service 707 may be performed based on user management for the information system.

Life cycle management service 708 may be provided according to embodiments of the invention for enabling management and storing of data and information in appropriate areas according to a life cycle of the data or information. This includes management methods so called HSM (hierarchical storage management) or tier management. Clients of life cycle management service 708 can specify a schedule (or conditions) for initiating migration of data to other areas (tiers) according to a life cycle of the data. In addition, clients of life cycle management service 708 can specify attribute regarding a new location of the migrated data, such as disk type (e.g., FC disk, SAS disk, SATA disk, Flash memory, and the like) and methods for reliability and availability of the data (e.g., mirroring (RAID1), RAID5, distributed storing of data, and the like).

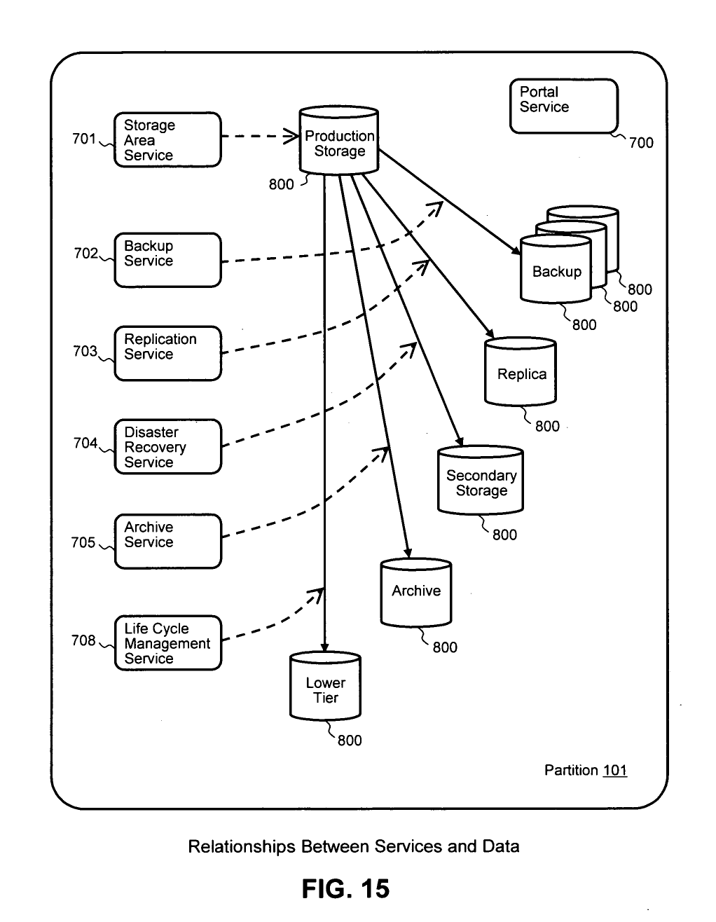

FIG. 15 illustrates a conceptual diagram providing an example of how each service manages data in a partition 101. Storage area service 701 manages original data (e.g., production data) used by application 501, which is stored in one of storage areas 800, and which has copies stored in other storage areas 800 with regards to each service (i.e., each purpose) according to requests received from host computer 500 for each service. Accordingly, each service manages the data copy process regarding the particular service, as shown by the dotted lines, including the conditions regarding the copy, such as location, disk type, etc. As illustrated, backup service 702 manages backup data stored in some storage areas 800, replication service 703 manages replicated data stored in some storage area 800, disaster recovery service 704 manages secondary data stored in some storage area 800, archive service 705 manages archive data stored in some storage area 800, and life cycle management service 708 manages data stored as lower tier data in one of storage areas 800.

Furthermore, a portal service 700 may be provided in each partition 101 for providing a common interface of all the other services 701-708 in the partition 101. Also, in addition to the services discussed above, other sorts of services, such as an encryption service and a data streaming service can be provided in some cases, if desired. Additionally, with regards to replication service 703 and disaster recovery service 704, the storage area selected to store replicated data or secondary data may be automatically selected from storage areas 800 which have the same storage attributes (e.g., disk type and reliability/availability) as the original (primary) data.

Configuration of Storage Server Computer

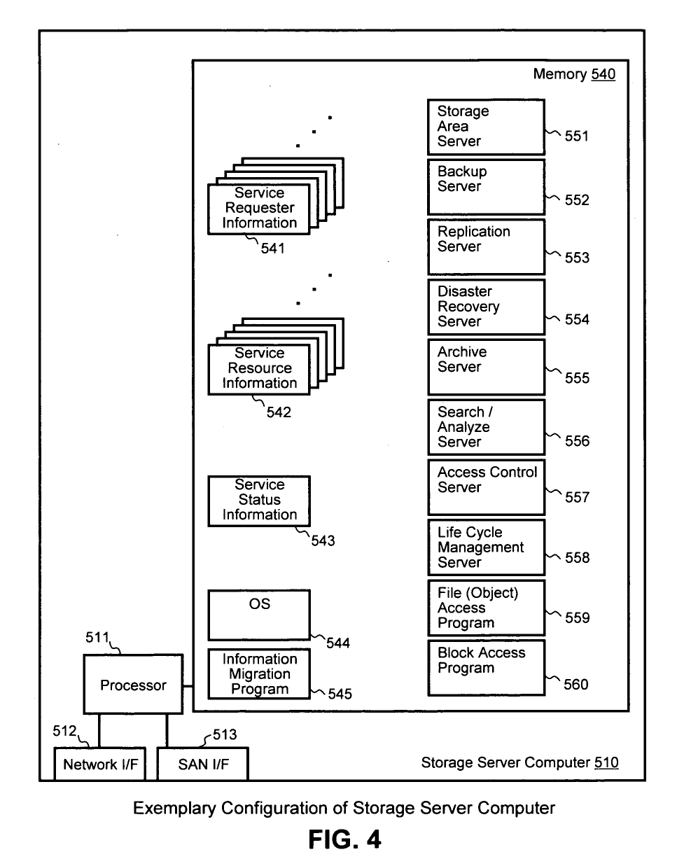

FIG. 4 illustrates an exemplary hardware and logical configuration of storage server computer 510. Storage server computer 510 may be a conventional computer, or the like, that includes a processor 511, a network interface (I/F) 512, a SAN interface 513, and a memory 540. Processor 511 performs various processing function in storage server computer 510. Processes carried out by processor 511 include processes to provide the services discussed above. To provide these services, processor 511 and other components use information, modules and data structures stored in memory 540, as follows.

Service requester information 541 is information that records the requestor of each service provided by the storage server 510.

Service resource information 542 is information that maintains information about assigned resources needed to provide each service. The process to assign and manage resources is described later.

Service status information 543 is information that maintains the status of the services, such as availability of the services.

In addition to an OS 544, memory 540 stores the following modules/programs, and processor 511 performs various processes regarding the storage server computer 510 by executing these modules/programs.

Storage area server 551 is a program used to provide storage area service 701. According to a request from requestor (e.g., an application 501), storage area server 551 supplies a storage area 800 from storage areas 800 provided by storage system 102.

Backup server 552 is a program used to provide backup service 702. In addition to a storage area 800, backup server 552 may use functions provided by storage system 102, such as local replication, continuous data protection, remote replication, deduplication and compression.

Replication server 553 is a program used to provide replication service 703. In addition to a storage area 800, replication server 553 may use functions provided by storage system 102, such as local replication, logical snapshot and remote replication.

Disaster recovery server 554 is a program used to provide disaster recovery service 704. In addition to a storage area 800, disaster recovery server 554 may use functions provided by storage system 102, such as remote replication.

Archive server 555 is a program used to provide archive service 705. In addition to a storage area 800, archive server 555 may use functions provided by storage system 102, such as local replication, logical replication, remote replication, WORM (write once, read many protection) with retention management, shredding, deduplication, compression and integrity checking by using hash values or comparison with replicas.

Search/analyze server 556 is a program used to provide search/analyze service 706. This program works as a so called search engine, with index management. Search/analyze server 556 may support an external search engine.

Access control server 557 is a program used to provide access control service 707. Access control server 557 may use functions provided by storage system 102, such as access control including LUN masking and authentication.

Life cycle management server 558 is a program used to provide life cycle management service 708. In addition to a storage area 800, life cycle management server 558 may use functions provided by storage system 102, such as transparent data relocation (migration).

File access program 559 is a program used to provide means to access files (objects) stored in storage system 102 via file access protocols such as NFS (network file system protocol) and CIFS (common Internet file system protocol). That is, file access program 559 recognizes file access commands and processes them.

Block access program 560 is a program used to provide means to access data stored in storage system 102 via block access protocols such as FC (Fibre Channel), iSCSI (internet SCSI) and FCoE (Fibre Channel over Ethernet).

Information migration program 545 is used to migrate the above-discussed information 541-543 from one storage server 510 to another storage server 510. A related process is described below.

Storage server 510 also has QoS control capability for each service to realize the partition 101 described above. In addition to this QoS control capability, such as guaranteeing performance, storage server computer 510 may use functions provided by storage system 102 such as QoS control and cache control.

Configuration of Management Computer

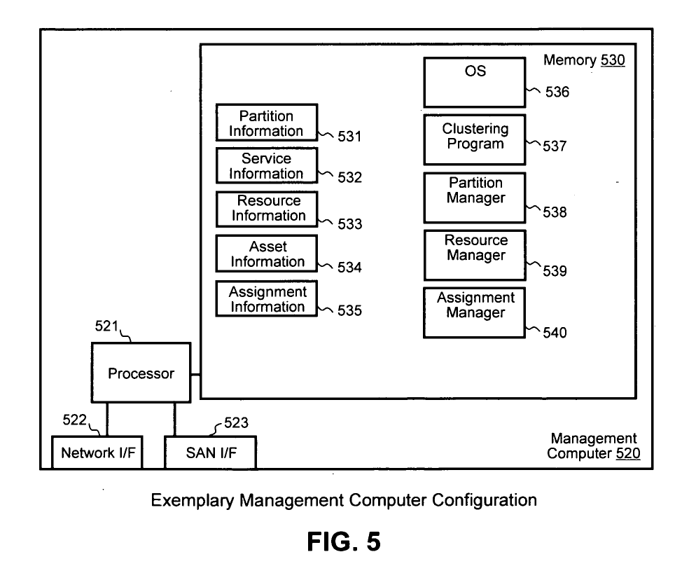

FIG. 5 illustrates an exemplary hardware and logical configuration of management computer 520. Management computer 520 may be a conventional computer having a processor 521, a network interface 522, a SAN interface 523, and a memory 530. Processor 521 performs various processes regarding the management computer 520. Processor 521 and other components use the following information, data structures and modules/programs stored in memory 530.

Partition information 531 maintains information regarding whether a partition 101 corresponding to partition ID exists or not, types of services provided in each partition 101, and engaged condition regarding each service, such as disk type being used, actual location of data, and methods implemented for reliability/availability, as mentioned above.

Service information 532 maintains information regarding resources required to provide each service and resources required to satisfy a particular condition, such as disk type, actual location and methods for reliability/availability.

Resource information 533 maintains information regarding a list of resources currently existing in storage platform 100. The resources listed include storage servers 510 (i.e., each server and its computing resources), storage areas and functions available in storage system 102. Resource information 533 also maintains the status and availability condition (e.g., free, used, failed) of each listed resource.

Asset configuration information 534 maintains information regarding a list of assets (i.e., equipment) currently present in storage platform 100. The assets include storage server computers 510, management computer 520, storage systems 102 and switches 910. Asset configuration information 534 also maintains the status and availability condition (e.g., free, used, failed) of each listed asset and the configuration of the equipment. By using this configuration information, management computer 520 can detect a change in the configuration of storage platform 100.

Assignment information 535 maintains information about the resources assigned to each service in each partition 101. In other words, assignment information 535 includes a mapping between resources and each service in each partition 101.

In addition to OS 536, memory 530 stores the following programs/modules, and processor 521 performs various processes on the management computer 520 by executing these programs/modules.

Clustering program 537 is a module used by management computer 520 to achieve clustering with another management computer 520. In other words, with clustering program 537, the management computer 520 can transfer the above-described information to the other management computer 520, and the other management computer 520 can take over processes from the former management computer 520 when a configuration change is carried out in the information system that includes replacing the former management computer 520.

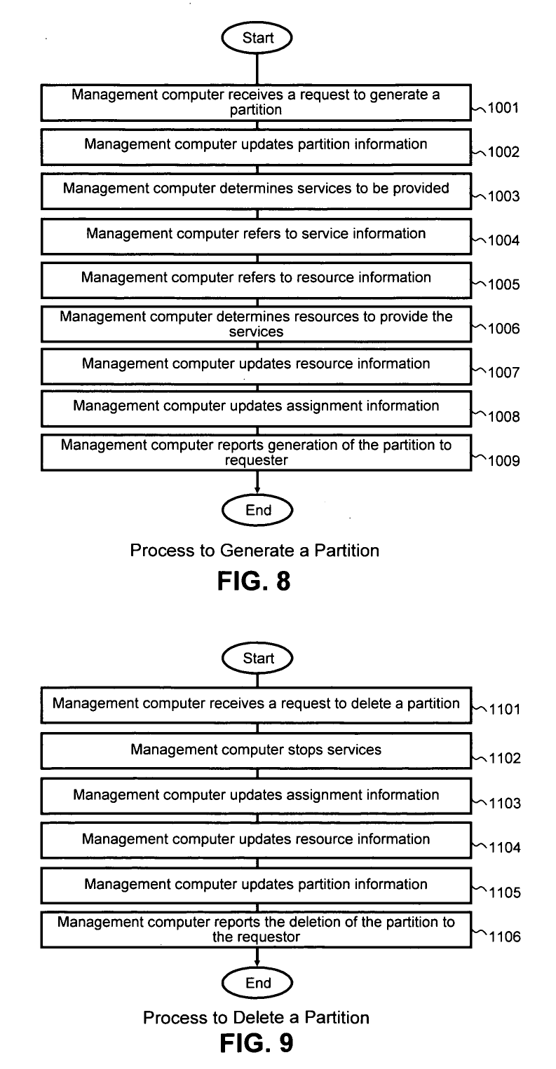

Partition manager 538 is a program that performs processes for generating and deleting a partition 101. The details of these processes are described additionally below with reference to FIGS. 8 and 9.

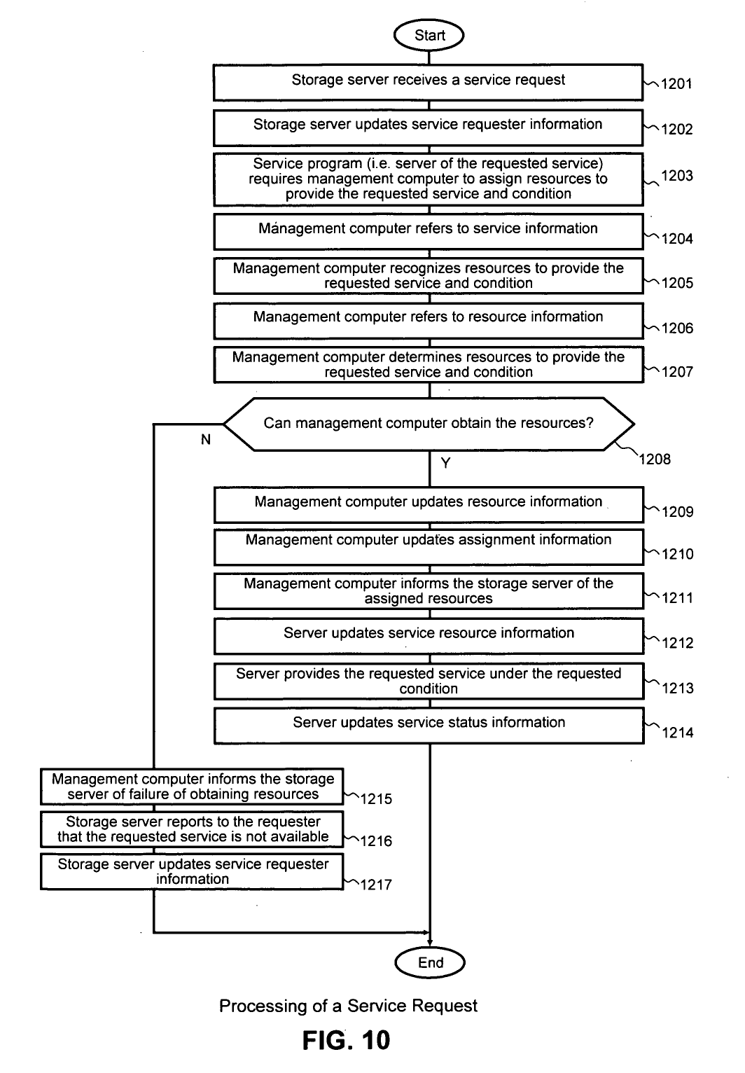

Resource manager 539 is a program that manages resource information 533 and asset information 534. Resource manager module 539 detects or handles a change of the resources in storage platform 100. The details of this module are described below with reference to FIGS. 10-12.

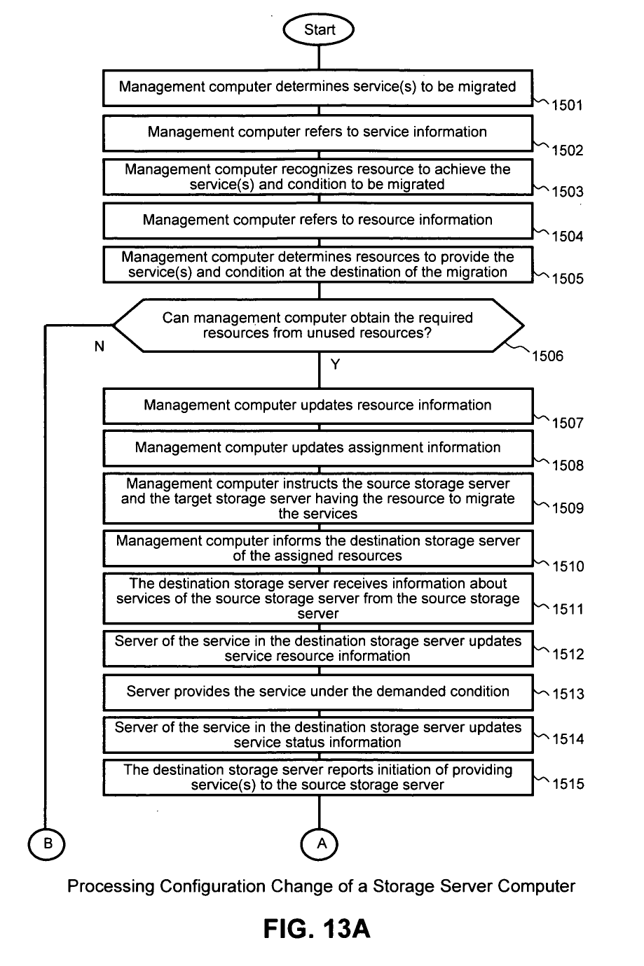

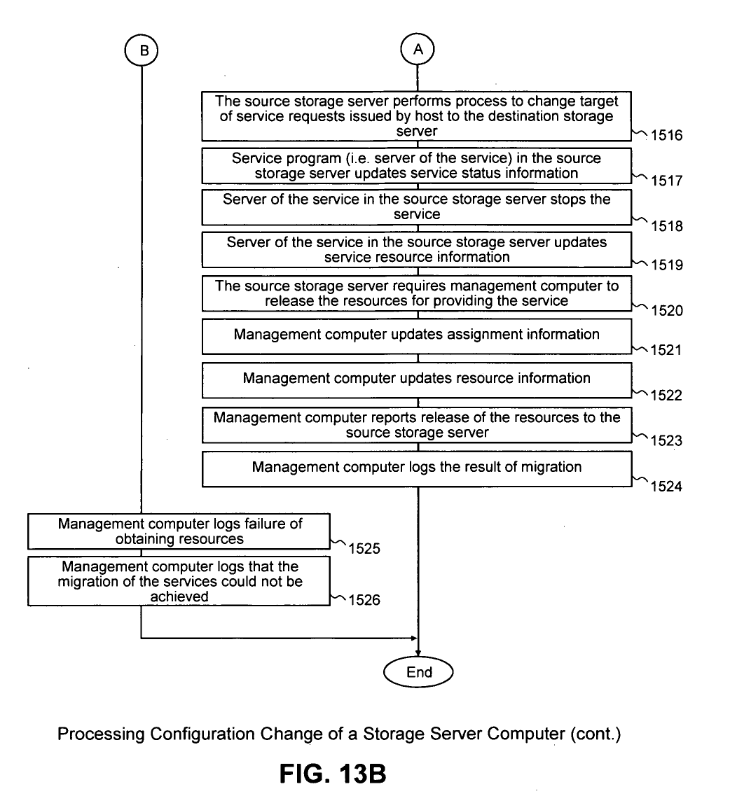

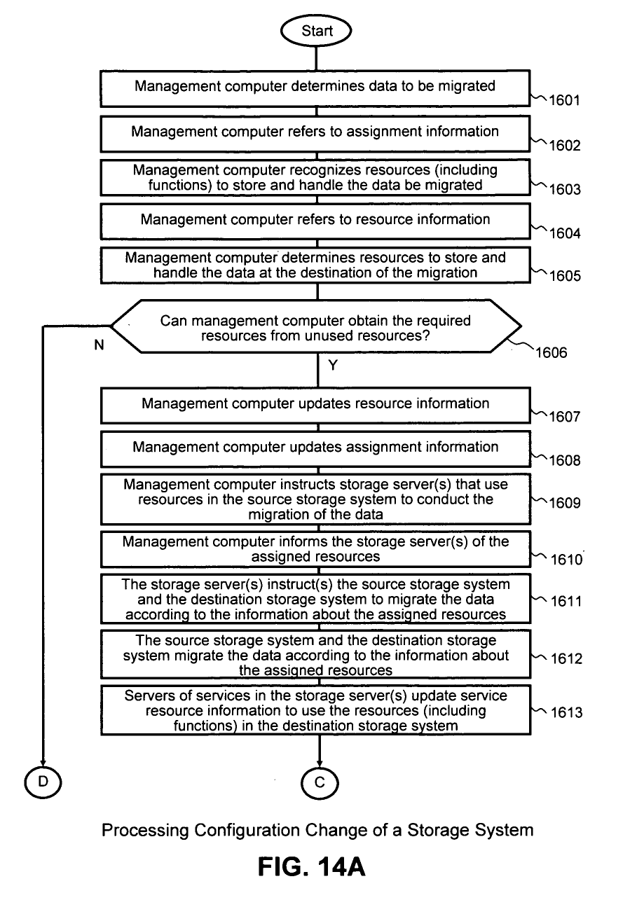

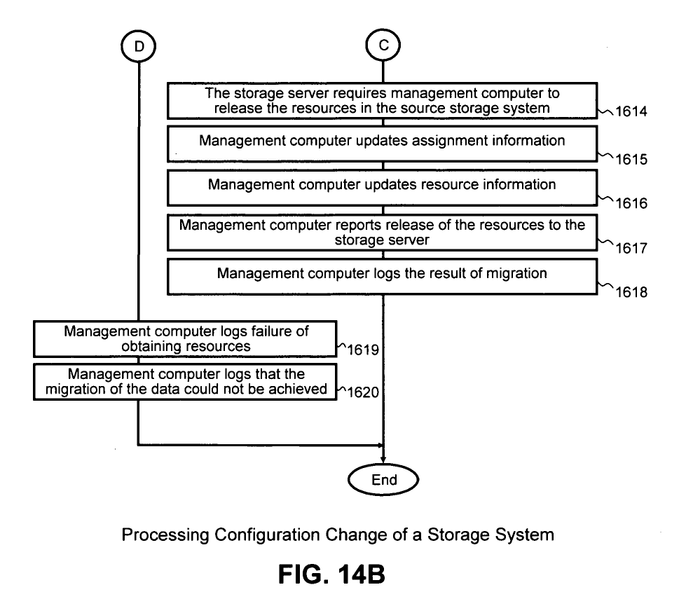

Assignment manager 540 is a program that manages assignment of resources to each service in each partition 101. Therefore, assignment manager program 540 manages assignment information 535 which specifies which resources of storage platform 100 are assigned to which partitions 101. The details of this module are described below with reference to FIGS. 13 and 14

Furthermore, while the programs, data structures and functions of the management computer are described in these embodiments as being implemented on a physically separate management computer 520, in other embodiments some or all of these programs, data structures and/or functions may be implemented using other computers or processing devices. Thus a management module may incorporate the functionality of the management computer 520 and be executed by one or more of the processing devices in the information system. For example, one or more of storage server computers 510 may implement the functionality of management computer 520, as described above and below, such as through installation of a management module or program on one or more of storage server computers 510, or the like. Additionally or alternatively, one or more of storage systems 102 may implement some or all of the functionality of management computer 520, as described above and below. Other alternative configurations will also be apparent to those of skill in the art in light of the disclosure provided herein, and the invention is not limited to any particular physical or logical configuration for management computer 520.

Configuration of Storage System

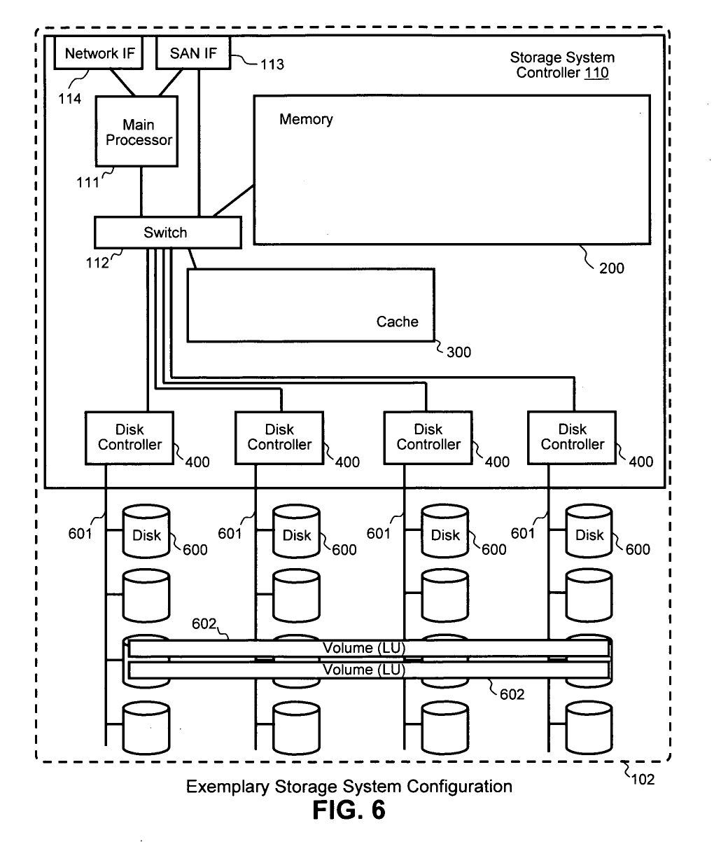

FIG. 6 illustrates an exemplary hardware and logical configuration of storage system 102. Storage system 102 includes a storage system controller 110 in communication with a plurality of storage devices 600. Storage system controller 110 includes a main processor 111, an internal switch 112, a SAN interface 113, a network interface 114, a memory 200, and a plurality of disk controllers 400. Storage devices 600 are hard disk drives (HDDS) in the illustrated embodiment (e.g. SATA HDD, FC HDD, etc.), but in other embodiments may be optical drives, solid state drives, such as Flash memory, or the like. A backend path 601 connects storage system controller 110 for communication with storage devices 600. A plurality of logical volumes 602 (i.e., logical units or LUs) may be created on storage devices 600 for use as storage areas 800.

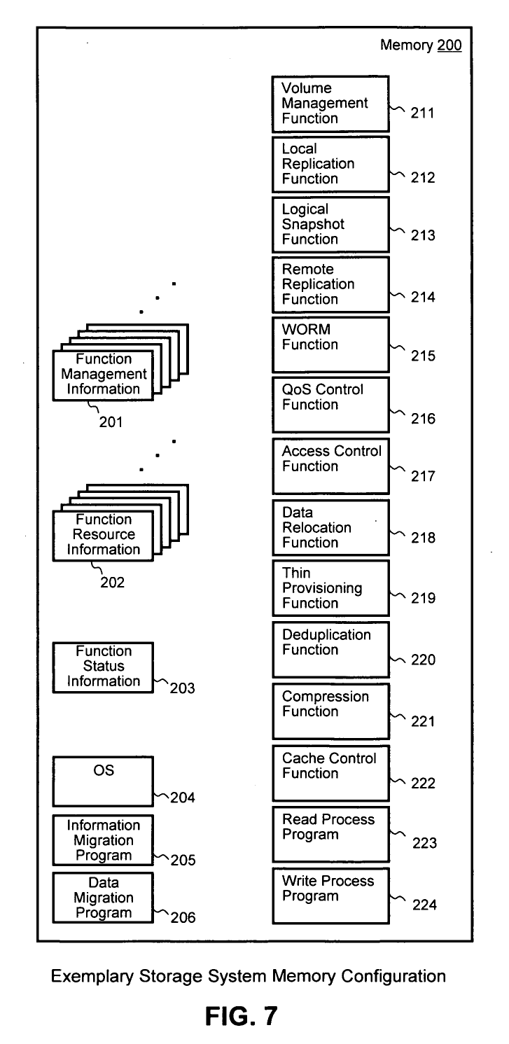

FIG. 7 illustrates an example of the logical configuration of storage system memory 200. Main processor 111 performs various processes regarding the storage system controller 110, and main processor 111 and other components use the following information, data structures and programs/modules stored in memory 200.

Function management information 201 maintains information regarding processes of each function of storage system 102. Examples of function management information 201 include: the target area/data of each function; conditions for copy processing; a source and destination of copying (i.e., copy relation or copy pair); retention periods regarding WORM data; and mappings between logical (or virtual) storage areas and physical storage areas.

Function resource information 202 maintains records of resources to be used for carrying out each function.

Function status information 203 maintains the status of each function, such as the availability of the functions.

Main processor 111 of storage system controller 110 provides functions or features by executing the following programs/modules stored in memory 200 of storage system controller 110.

Volume management function 211 creates and manages the volumes in storage system 102. More details regarding this function may be garnered from U.S. Pat. No. 7,222,172, which was incorporated herein by reference above, by referring to “Definition of volumes” and “Volume management”, such as with regards to the description of FIG. 3 in U.S. Pat. No. 7,222,172.

Local replication function 212 manages replication and snapshots in storage system 102. More details regarding this function may be garnered from U.S. Pat. No. 7,222,172, which was incorporated herein by reference above, by referring to “snapshots”, such as with regards to the description of FIG. 3 in U.S. Pat. No. 7,222,172.

Logical snapshot function 213 is a function or module that provides a logical snapshot without an actual secondary storage area. One example of a method used to achieve this is maintaining old data by copy-on-write. The management method of these snapshots is almost same as local replication mentioned above.

Remote replication function 214 provides for remote replication from storage system 102. More details regarding this function may be garnered from U.S. Pat. No. 7,222,172, which was incorporated herein by reference above, by referring to “remote replication”, such as with regards to the description of FIG. 3 in U.S. Pat. No. 7,222,172.

WORM function 215 is a function or module that provides write protection (prohibition against modification of the data) based on a predetermined retention period. After the retention period has expired, shredding of the data may be performed.

QoS control function 216 manages the quality of service in storage system 102. More details regarding this function may be garnered from U.S. Pat. No. 7,222,172, which was incorporated herein by reference above, by referring to “port control”, such as with regards to the description of FIG. 3 in U.S. Pat. No. 7,222,172. In addition, QoS control function 216 can control QoS (performance) of each component (resource) such as main processor 111, cache 300, internal switch 112, disk controller 400, and network interfaces in the storage system 102.

Access control function 217 provides LUN masking, authentication, and so on. Protocol standard specifications such as FC-SP and IPSec are also available. More details regarding access control function 217 may be garnered from U.S. Pat. No. 7,222,172, which was incorporated herein by reference above, by referring to “security control”, such as with regards to the description of FIG. 3 in U.S. Pat. No. 7,222,172.

Data relocation function 218 provides for relocation of data. More details regarding this function may be garnered from U.S. Pat. No. 7,222,172, which was incorporated herein by reference above, by referring to “volume relocation”, such as with regards to the description of FIG. 3 in U.S. Pat. No. 7,222,172. In addition, as disclosed in US Pat. Appl. Pub. No. 2006/0010169, to M. Kitamura, which was incorporated by reference herein above, relocation with finer units (e.g. extent, page, segment, block, etc.) can be performed in any similar manner, and relocation of files is also available.

Thin provisioning function 219 is a function or module that realizes use of storage areas in an on-demand basis by assigning storage area from common storage area pool only when a storage areas actually needed for use.

Deduplication function 220 is a function or module that reduces wasted space in a storage system by aborting storage of redundant data. Typically, as is known in the art, the de-duplication function detects duplication of contents through comparison of contents or their hash values. That is, the de-duplication function 220 realizes reduction of consumption of actual storage area by locating and deleting redundant data.

Compression function 221 is a function or module that realizes a reduction in consumption of actual storage capacity by compression/decompression of the data stored in a storage system.

Cache control function 222 is a function or module that controls the use of cache 300. More details regarding this function may be garnered from U.S. Pat. No. 7,222,172, which was incorporated herein by reference above, by referring to “cache control”, such as with regards to the description of FIG. 3 in U.S. Pat. No. 7,222,172. In addition, cache control function 222 also provides separated use of cache 300 for different users.

Read process program 223 is a function or module that performs the processes necessary for read access.

Write process program 224 is a function or module that performs the processes necessary for a write access.

Other types of functions and processes regarding data stored in the storage system 102 may also be performed in addition to those discussed above. Function management information 201 and function resource information 202 maintains information regarding these functions as mentioned above.

Moreover, memory 200 has the following programs, in addition to OS 204.

Information migration program 205 is a module used to migrate the above-described information 201-203 from one storage system 102 to another storage system 102.

Data migration program 206 is a module used to migrate data stored in storage system 102 from the storage system 102 to another storage system 102. An exemplary process using these programs is described below with respect to FIG. 13.

Process to Generate a Partition

FIG. 8 illustrates an exemplary process according to embodiments of the invention for generating a partition 101 in the storage platform 100. During the generation of the partition a process is performed for assuring that the resources (i.e., capabilities and performance) necessary for carrying out fundamental services will be available to the partition 101 independently of other partitions 101.

At step 1001, management computer 520 receives a request from a user or an application 501 to generate a partition 101.

At step 1002, management computer 520 updates partition information 531.

At step 1003, management computer 520 determines the services to be provided. For example, a default set of services can be predetermined. As another example of this method, the above request received in step 1001 can include information to specify the services to be provided.

At step 1004, management computer 520 refers to service information 532 to determine any resources necessary for providing the services identified in step 1003.

At step 1005, management computer 520 refers to resource information 533 to locate the resources identified in step 1004.

At step 1006, management computer 520 selects the resources to be used to provide the services.

At step 1007, management computer 520 updates the resource information 533 to obtain the resources selected in step 1006.

At step 1008, management computer 520 updates assignment information 535 to show that the selected resources have been assigned to the newly-generated partition.

At step 1009, management computer 520 reports the completion of generating the new partition 101 to the requester.

Process for Deletion of a Partition

FIG. 9 describes a process for deletion of a partition 101 in the storage platform 100.

At step 1101, management computer 520 receives a request from a user or an application 501 to delete a particular partition 101.

At step 1102, management computer 520 instructs the related storage server(s) to stop services in the partition 101.

At step 1103, management computer 520 updates assignment information 535 to release the resources for the partition 101.

At step 1104, management computer 520 updates resource information 533 to release the resources for the partition 101.

At step 1105, management computer 520 updates partition information 531 to delete the specified partition 101 from the partition information 531.

At step 1106, management computer 520 reports the completion of deletion of the partition 101 to the requester.

Process to Provide a Service

FIG. 10 illustrates an exemplary process according to embodiments of the invention for initiating (providing) a service according to a service request for a partition 101. In the process, according to the particular service and the conditions specified in the request, a process for assuring resources independent of other partitions 101 is performed with regards to the resources required to provide the particular service with the specified conditions, in addition to resources that the partition 101 already has assigned. For example, when the service request is for maintaining a replica of the data stored in the partition, additional resources, such as a storage area for the replica, computing resources to perform copying, and a memory area to manage the copy process and the replica are prepared, and the management computers that these resources will be sufficient for carrying out the requested service regardless of what is occurring in other partitions.

At step 1201, a storage server computer 510 assigned to the targeted partition 101 receives a request from a user or an application 501 for a service. This request can specify certain conditions regarding the requested service, such as attributes regarding location for storage of the replicated data, such as disk type (e.g. FC disk, SAS disk, SATA disk, Flash memory), actual location (e.g., at a separated area from a failure event perspective, at a separate storage system from original data or at a remote site, etc.), reliability/availability, backup cycle/scheme and/or a retention period.

At step 1202, the storage server 510 updates service requester information 541 to record the requestor.

At step 1203, service program (i.e., the server module of the requested service) in the storage server 510 requires management computer 520 to assign resources to provide the services while also satisfying the specified conditions.

At step 1204, management computer 520 refers to service information 532 to determine the necessary resources.

At step 1205, management computer 520 selects the resources necessary to provide the requested service and any specified conditions.

At step 1206, management computer 520 refers to resource information 533 to seek the resources.

At step 1207, management computer 520 determines the resources required to provide the requested services and the condition.

At step 1208, when management computer 520 is able to locate the necessary resources, the process proceeds to step 1209. On the other hand, when management computer 520 is not able to locate the necessary resources, the process proceeds to step 1215.

At step 1209, management computer 520 updates the resource information 533 to obtain the identified resources.

At step 1210, management computer 520 updates assignment information 535 for the identified resources.

At step 1211, management computer 520 informs the storage server 510 of the assigned resources.

At step 1212, with the information received from management computer 520, the server module that requested to assign the resources (i.e., one of the server modules 551-558) updates the service resource information 542.

At step 1213, the server module provides the requested service according to any requested conditions.

At step 1214, the server module updates the service status information 543.

At step 1215, management computer 520 informs the storage server 510 of failure in obtaining the necessary resources.

At step 1216, storage server 510 reports to the requester that the requested service is not available.

At step 1217, the storage server 510 updates the service requester information 541.

Accordingly, it may be seen that through the above process, the requested service is provided. This process is able to operate to modify services that are already being supplied. This process also can serve to modify the conditions regarding services already being supplied, while a method similar to that described next can be used when a release of resources is needed for the modification of the conditions regarding services already being supplied.

Process to Stop a Service

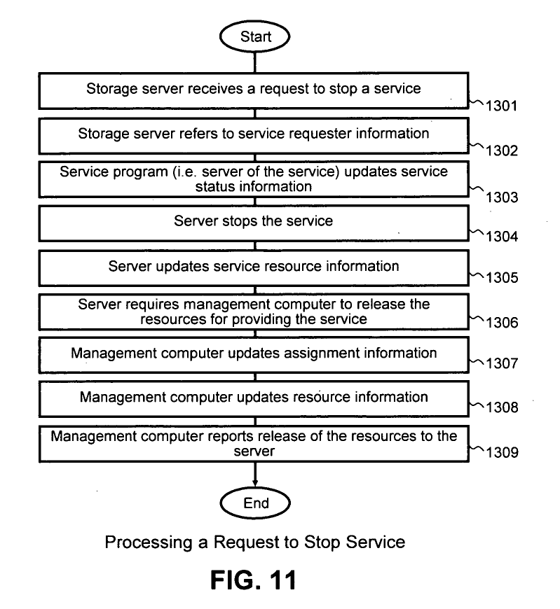

FIG. 11 illustrates an exemplary process according to embodiments of the invention for stopping a service according to a service request received for a partition 101.

At step 1301, storage server 510 assigned to the targeted partition 101 receives a request to stop a service from a user or an application 501.

At step 1302, storage server 510 refers to service requester information 541.

At step 1303, the targeted service program (i.e., one of the server modules 551-558 of the requested service) updates the service status information 543.

At step 1304, the targeted server stops the service.

At step 1305, the targeted server updates the service resources information 542.

At step 1306, the targeted server sends a request to management computer 520 to release the resources for the service.

At step 1307, management computer 520 updates assignment information 535.

At step 1308, management computer 520 updates resource information 533 to release the resources.

At step 1309, management computer 520 reports completion of release of the resources to the affected storage server 510.

Changing Configuration of Storage Platform

As discussed above, one of the characteristics of a partition 101 of embodiments of the invention is that the partition 101 provides services, engaged quality of the services, and engaged conditions about resources, regardless of any changes that might take place in the configuration of the information system. In other words, a change in the configuration of the storage platform 100 does not affect the partitions 101 that are in existence on the storage platform 100.

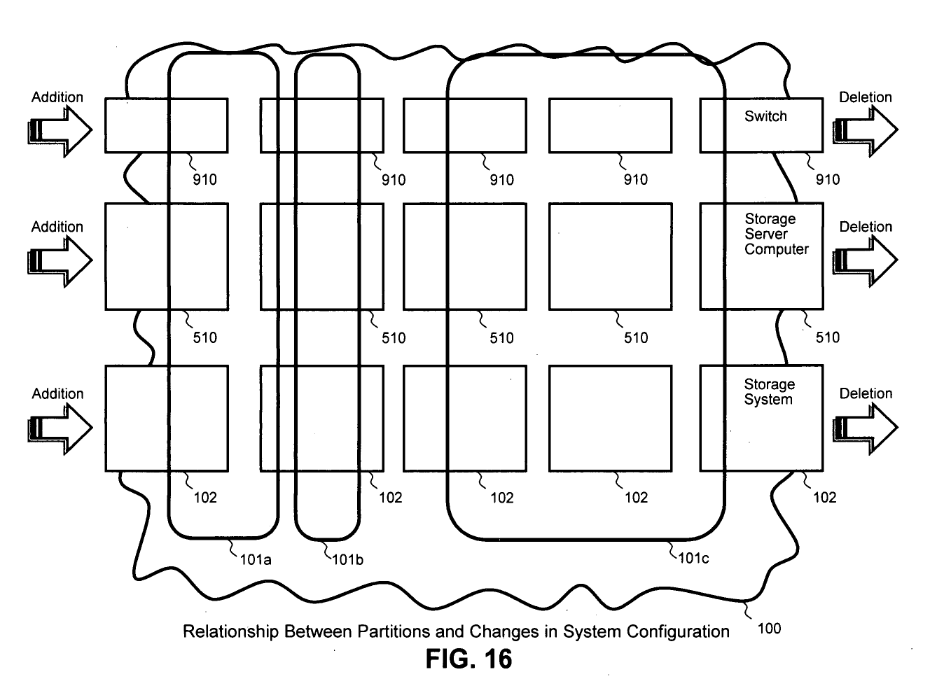

FIG. 16 illustrates an example of a conceptual diagram regarding the relationship between a change in the configuration of the information system and how the partitions 101 existing in the information system are affected by the change. In the example of FIG. 16, equipment (e.g., switches 910, storage server computers 510, management computer 520 and storage systems 102) can be dynamically added to storage platform 100 as renewal or reinforcement, while other equipment can be dynamically deleted from the storage platform 100 for repurposing or retirement. Each partition 101 according to embodiments of the invention includes the capability to continue providing services according to the same existing conditions, regardless of the configuration changes taking place in the storage platform 100, such as addition or deletion of a switch 910, a storage server computer 510, a management computer 520 or a storage system 102. To achieve this result, service, information and data on affected pieces of equipment are migrated to other equipments according to the configuration change detected by management computer 520. For example, as illustrated in FIG. 16, as equipment is added partition 101a may be extended to make use of the newly added equipment, while partition 101c will be extended to other equipment in the storage platform 100, as equipment that partition 101c is currently using is designated to be removed.

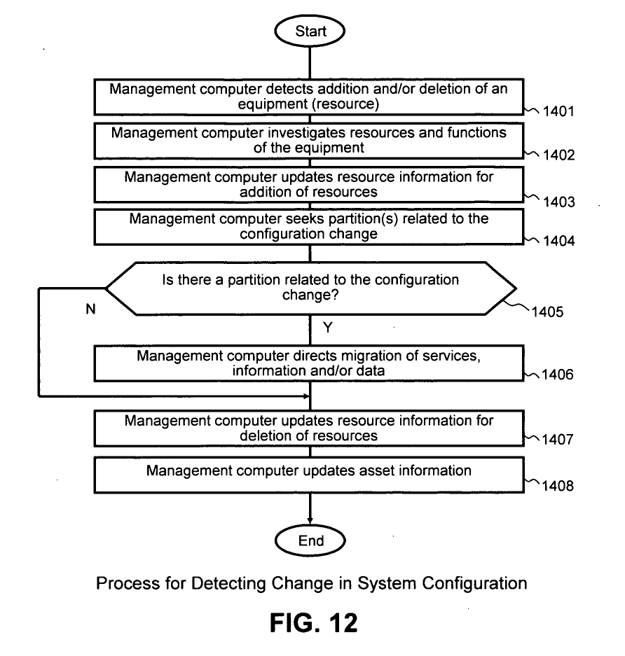

FIG. 12 illustrates an example of a process for detection of a configuration change in storage platform 100.

At step 1401, by using asset information 534, management computer 520 detects the addition and/or deletion of equipment such as switch 910, storage server 510 and storage system 102. Conventional methods for CMDB can be used for the detection.

At step 1402, management computer 520 investigates the resources and functions of the equipment in the storage platform 100.

At step 1403, management computer 520 updates resource information 533 for addition of resources, and makes the added resources available.

At step 1404, management computer 520 searches for any partition(s) related to affected resources.

At step 1405, when management computer 520 finds any partition(s) related to affected resources, the process proceeds to step 1406. If not, the process proceeds to step 1407.

At step 1406, management computer 520 directs migration of services, information and/or data of any affected partitions. The detailed processes are described later with respect to FIGS. 13 and 14.

At step 1407, management computer 520 updates resource information 533 for deletion of the resources.

At step 1408, management computer 520 updates asset information 534, and the process ends.

Configuration Change Relating to Storage Server

FIGS. 13A-13B illustrate an exemplary process for a change in configuration related to a storage server 510 for maintaining services in an affected partition and any specified conditions regarding the services.

At step 1501, management computer 520 determines services to be migrated.

At step 1502, management computer 520 refers to service information 532 to determine the current resources.

At step 1503, management computer 520 identifies the resources being used to achieve the services and the specified conditions to be migrated.

At step 1504, management computer 520 refers to resource information 533 to seek comparable resources.

At step 1505, management computer 520 identifies at the destination of the migration the resources necessary to achieve the services and the conditions to be migrated. In making the identification, the type of resources (including functions) can be different between the source and the destination as equivalents. For example, to realize access control service 707 with the same condition, functions for iSCSI can be used as alternative of method for FC when the source uses FC and the destination uses iSCSI protocol.

At step 1506, when management computer 520 is able to identify sufficient available if resources at the migration destination, the process proceeds to step 1507. If not, the process proceeds to step 1525.

At step 1507, management computer 520 updates the resource information 533 to obtain the resources.

At step 1508, management computer 520 updates the assignment information 535.

At step 1509, management computer 520 instructs the source storage server 510 (i.e., the source of migration) and the target storage server 510 (i.e. the target of migration) to migrate the services between them.

At step 1510, management computer 520 informs the destination storage server 510 of the assigned resources.

At step 1511, the destination storage server 510 receives information about services to be migrated from the source storage server 510. That is, migration of the aforesaid information regarding services of the source storage server 510 is performed.

At step 1512, with the received information from management computer 520 and the source storage server 510, server modules on the destination storage server 510 update service resource information 542.

At step 1513, the server modules on the destination storage server 510 start to provide the service according to any specified condition.

At step 1514, the server modules on the destination storage server 510 update service status information 543.

At step 1515, the destination storage server 510 reports initiation of providing services to the source storage server 510.

At step 1516, the source storage server 510 performs process to change target of service requests issued by the user (e.g., an application on host 500) to the destination storage server 510. To achieve this, conventional methods and processes may be used, such as use of multipath software, updating information of name server and redirection of the requests.

At step 1517, server modules on the source storage server 510 update service status information 543.

At step 1518, server modules on the source storage server 510 stop the services.

At step 1519, the server modules on the source storage server 510 update service resources information 542.

At step 1520, the source storage server 510 sends a request to management computer 520 to release the resources for the service.

At step 1521, management computer 520 updates assignment information 535.

At step 1522, management computer 520 updates resource information 533 to release the resources.

At step 1523, management computer 520 reports completion of the release of the resources to the source storage server 510.

At step 1524, management computer 520 logs the result of migration.

At step 1525, management computer 520 logs failure of obtaining the necessary resources.

At step 1516, management computer 520 logs that the migration of the services could not be achieved.

With the above process, for a configuration change relating to one of storage server computers 510, partitions 101 in storage platform 100 are maintained with their services and any specified conditions regarding the services. In addition to logging success or failure of the process, management computer 520 may report the success or failure to a user and/or administrator of the configuration change. Furthermore, the above migration may be performed from one source storage server 510 to plural destination storage servers 510.

Configuration Change Relating to Storage Systems

FIGS. 14A-14B illustrate an exemplary process that may be carried out for implementing a change in the system configuration resulting from a storage system 102 configuration change so that services in affected partitions are maintained.

At step 1601, management computer 520 determines any data to be migrated.

At step 1602, management computer 520 refers to assignment information 535 to recognize necessary resources currently being used.

At step 1603, management computer 520 determines what resources (includes functions) will be necessary for storing and handling the data to be migrated.

At step 1604, management computer 520 refers to resource information 533 to seek availability of the resources determined in step 1603.

At step 1605, management computer 520 determines which resources will store and handle the data at the destination of the migration. In making the determination, the type of resources (including functions) can be different between the source and the destination as equivalents. For example, to realize access control service 707 with the same conditions, functions for iSCSI can be used as an alternative to FC when the source uses FC and the destination uses iSCSI protocol.

At step 1606, when management computer 520 is able to locate the necessary resources at a suitable destination, the process proceeds to step 1607. If not, the process proceeds to step 1619.

At step 1607, management computer 520 updates the resource information 533 to obtain the necessary resources at the destination storage system 102.

At step 1608, management computer 520 updates assignment information 535 to reflect selection of the resources at the destination storage system 102.

At step 1609, management computer 520 instructs storage server computer(s) 510 that use(s) the resources in the source storage system 102 (i.e., the source of the migration) to conduct the migration of the data to the destination storage system 102.

At step 1610, management computer 520 informs the storage server computer(s) 510 of the newly assigned resources.

At step 1611, the storage server computer 510 instructs the source storage system 102 and the destination storage system 102 (i.e., destination of the migration) to migrate the date between them according to the information regarding the assigned resources.

At step 1612, the source storage system 102 and the destination storage system 102 relocate the data according to the information regarding the assigned resources. To achieve this, remote replication function 214 of storage system 102 can be used as a conventional method. As another conventional method, storage server 510 may perform relocation processing including copying of the data from the source storage system 102 to the destination storage system 102.

At step 1613, servers on the storage server 510 update service resource information 542 to use the resources (including functions) in the destination storage system 102.

At step 1614, the storage server 510 sends a request to management computer 520 to release the resources in the source storage system 102.

At step 1615, management computer 520 updates assignment information 535 with regards to the released resources.

At step 1616, management computer 520 updates resource information 533 to release the resources of the source storage system 102.

At step 1617, management computer 520 reports completion of release of the resources of the source storage system 12 to the storage server computer 510.

At step 1618, management computer 520 logs the result of migration.

At step 1619, management computer 520 logs failure to obtaining the necessary resources at any destination storage system 102.

At step 1620, management computer 520 logs that the migration of the services could not be achieved.

With the above process, for a configuration change relating to storage system 102, partitions 101 in storage platform 100 are maintained in keeping with their specified services and any specified conditions regarding the services. In addition to logging success or failure of the process, management computer 520 may report the success or failure to a user and/or administrator managing the configuration change. The above migration may be performed from one source storage system 102 to plural destination storage systems 102, from plural source storage systems 102 to a single destination storage system 102, or from plural source storage systems 102 to plural destination storage systems 102. Occurrence of a process for configuration change relating to storage server 510 mentioned above and a process for configuration change relating to storage system 102 may be arranged by management computer 520 to avoid or resolve any conflicts that may arise between the processes executed for the configuration changes. That is, exclusive execution of the configuration change may be achieved by management computer 520.

Configuration Change Relating to Management Computer

As discussed above, through use of clustering program 537, management computer 520 includes clustering capability. By using this clustering capability, plural management computers 520 are able to make up a cluster, and can maintain their functions and processes through coupling and decoupling within the cluster, even if addition or deletion of a management computer 520 occurs.

Configuration Change Relating to Switches

As a conventional method, switches 910 can be arranged in a redundant configuration to maintain paths and other functions for addition or deletion of switches in a network. Accordingly, when a switch is added or removed from the storage platform 100, redundancy of the switches ensures that operation of individual partitions is not affected.

Relocation of Partitions

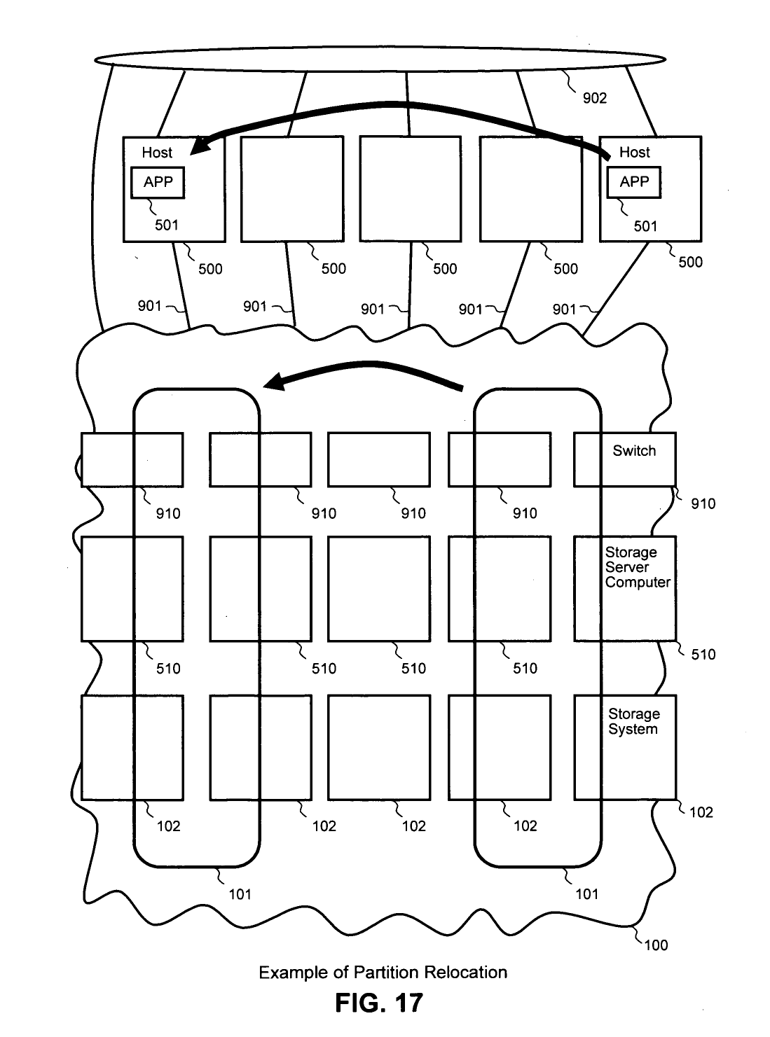

FIG. 17 illustrates the movability of partitions and an example of relocation of a partition. When an application 501 is moved to a different physical location by my various known methods, such as virtual machine (VM) migration in order to realize load balancing, recovery from a failure, or the like, a partition (i.e., independent resources and services) used by the application 501 may be required to change physical location in storage platform 100 in accordance with the migration of the application 501. By implementing the processes described above, such as in FIGS. 13A-13B and 14A-14B, the partition 101 can achieve a change in its physical location through migration of services, information and data. That is, movability or portability of the partition 101 can be achieved. This movability of partitions 101 can be used to achieve balancing (location optimization) of loads, heat, and power consumption in storage platform 100 by monitoring of such metrics as load on individual pieces of equipment, local temperatures in the storage platform 100, and power consumed by various pieces of equipment, respectively. For example, management computer 520 may be configured to monitor these metrics and, when a predetermined threshold is reached for a particular metric, a partition may be migrated from one portion of the storage platform 100 to a different portion by reassignment of the storage server computer resources, the storage system resources, and possibly the switch resources.

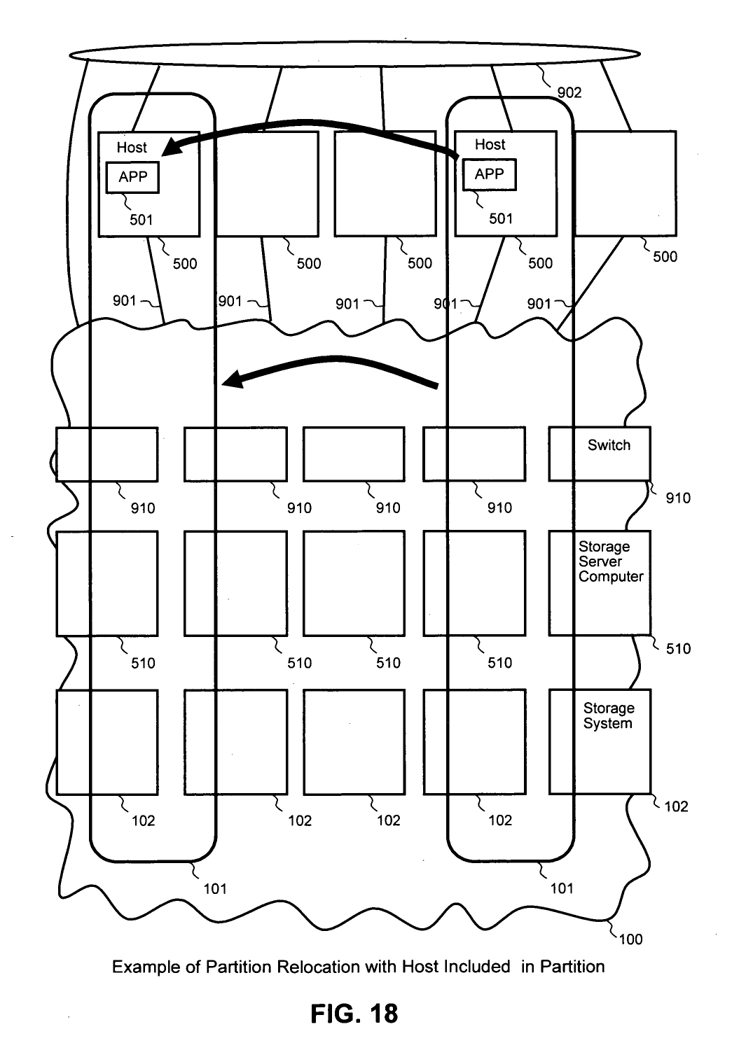

FIG. 18 illustrates the movability of partitions and an example of relocation of a partition when the partition 101 also includes one or more processes in host computer 500 in the partition 101. As known methods, host computer 500 can have a capability to possess logical partitions for its processes, therefore a unified partition 101 including resources of host computer 500 and storage platform 100 can be realized by integration of the partition management mentioned above and partition management of host computer 500. Moreover, the unified partition can be relocated when the process(es) on the host computer 500 are migrated to a different host computer 500 by my various known methods, such as virtual machine (VM) migration. This may be carried out in order to realize load balancing, recovery from a failure, or the like.

With the systems and the processes in the exemplary embodiments described above, a storage platform 100 can establish durable partitions 101 that are unified across storage systems and storage server computers. The unified durable partitions provide independent name spaces, and are able to maintain specified services and conditions regardless of operations taking place in other partitions, and regardless of configuration changes in the information system. The durable partitions of the exemplary embodiments are unified across both storage systems and storage server computers, and also may include switches in the information system, and, in some embodiments, processes in the host computers. Furthermore, in addition to being durable and resistant to configuration changes, partitions 101 can have mobility within the storage platform 100 for various purposes such as improved performance, load balancing, heat balancing, and power consumption considerations. The management computer is able to manage and assign resources and functions provided by storage server computers and storage systems to each partition. By using the assigned resources, a partition is able to provide storage and other services to the host computer and applications on the host computer. When a configuration change occurs, such as addition or deletion of equipment in the information system, the management computer performs reassignment of resources, manages migration of services and/or data, and otherwise maintains the functionality of the partition for the user or application. Also, in addition to services and quality of the services, engaged conditions regarding resources are also maintained. Moreover, for relocation of partition in the information system, the above principles of the partition are maintained by above manner when a partition is relocated to another part of the information system.

Of course, the system configurations illustrated in FIGS. 1-7 and 15-18 are purely exemplary of information systems in which the present invention may be implemented, and the invention is not limited to a particular hardware configuration. For example, storage server and storage system may not be separated and may form an integrated storage system. That is, the storage system may include features and capabilities of storage server mentioned above. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures and information of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for implementing durable partitions in an information system. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A method of operating an information system comprising:
implementing a plurality of storage computers providing first resources and a plurality of storage systems providing second resources, said second resources including a plurality of storage areas;
creating a first logical partition having a first identifier, said first logical partition including a first portion of said first resources and a first portion of said second resources; and
carrying out a first service via said first logical partition.

2. The method according to claim 1, further including steps of
changing a configuration of said information system such that at least one of said first resources or said second resources is affected by the change in the configuration;
determining whether said first portion of said first resources or said first portion of said second resources included in the first logical partition is affected by the change in the configuration; and
assigning additional first resources or second resources, respectively, to said first logical partition when said first portion of said first resources or said first portion of said second resources is affected by the change in the configuration, so that said first service continues to be provided following the change in configuration.

3. The method according to claim 2,
wherein said step of changing the configuration includes at least one of:
adding a new storage computer or a new storage system to the information system; and
removing a storage computer or a storage system from the information system.

4. The method according to claim 1, further including steps of
receiving a service request at a first one of said storage computers, said service request requesting implementation of a second service to be carried out by said second resources in said first partition;
determining whether sufficient second resources are available in the information system for implementation of the service; and
assigning additional second resources to said first partition for implementation of the second service when sufficient second resources are available in the information system.

5. The method according to claim 4,
wherein, when the service request includes one or more conditions specified for carrying out the second service, further including steps of
determining whether sufficient second resources are available in the information system for meeting the one or more conditions specified for carrying out the second service; and
assigning additional second resources to said first partition for implementation of the second service and the one or more conditions specified when sufficient second resources are available in the information system.

6. The method according to claim 1, further including a step of
providing one or more management computers in said information system for managing assignment of said first resources and said second resources to logical partitions including said first logical partition for use in generating or deleting the logical partitions.

7. The method according to claim 1, further including a step of
providing a plurality of management computers in said information system for managing logical partitions in the information system including the first logical partition; and
arranging said management computers as a cluster, whereby said management computers share management information between them, so that if one of said management computers fails or is removed from the information system, the other management computers continue to carry out management of the logical partitions.

8. The method according to claim 1, further including steps of
migrating said first partition within said information system by assigning a second portion of said first resources and a second portion of said second resources to said first partition for carrying out said first service, and
releasing said first portion of said first resources and said first portion of said second resources from said first partition.

9. The method according to claim 8, further including steps of
providing a plurality of host computers in communication with said storage computers and said storage systems, said host computers configured to run one or more applications;
including a first application on a first host computer in said first partition; and
migrating said first application to a different host computer as part of migrating said first partition.

10. The method according to claim 8, further including at least one of
copying information about said first service to said second portion of the first resources, or copying data related to said first service to said second portion of said second resources.

11. The method according to claim 10,
wherein the information about said first service is copied from said first portion of said first resources to said second portion of said first resources prior to release of the first portion of the first resources, and/or the data related to said first services is copied from said first portion of said second resources to said second portion of said second resources prior to release of the second portion of the second resources.

12. The method according to claim 1, further including steps of
generating a second logical partition in said information system, said second logical partition having a second identifier and including a second portion of said first resources and a second portion of said second resources, separate from said first portion of said first resources and said first portion of said second resources, respectively; and
carrying out a second service in said second logical partition, whereby operation of said second service does not affect operation of said first service in said first logical partition.

13. The method according to claim 1, further including a step of
providing a plurality of switches in communication with said storage computers and said storage systems, wherein said first partition includes one or more of said switches as third resources in said first partition.

14. An information system comprising:
a plurality of storage computers for providing first resources;
a plurality of storage systems for providing second resources, said second resources including storage devices for storing data;
at least one management computer in communication with said storage computers and said storage systems;
a first logical partition created in said information system using a first portion of said first resources and a first portion of said second resources;
wherein, when a configuration of said information system is changed such that at least one of said first resources or said second resources is affected by the change in the configuration, the management computer is configured to detect the change in the configuration and determine whether said first portion of said first resources or said first portion of said second resources included in the first logical partition is affected by the change in the configuration; and
wherein, when said first portion of said first resources or said first portion of said second resources is affected by the change in the configuration, said management computer is configured to assign additional first resources or second resources, respectively, to said first logical partition.

15. The information system according to claim 14,
wherein said management computer creates said first logical partition by assigning the first portion of said first resources and the first portion of said second resources to the first logical partition.

16. The information system according to claim 14, further comprising:
a plurality of switches in communication with said storage computers and said storage systems, wherein said first partition includes one or more of said switches as third resources in said first partition.

17. The information system according to claim 14, further comprising:
one or more services provided via said first partition, wherein operation of said one or more services continues to be carried out following the change in the configuration.

18. The information system according to claim 14, further comprising:
a plurality of host computers in communication with said storage computers and said storage systems, said host computers having one or more applications running thereon,
wherein a first application of said one or more applications is included in said first partition.

19. A method of partitioning an information system comprising:
implementing a storage platform in communication with a plurality of host computers, said storage platform including a plurality of storage computers providing first resources and a plurality of storage systems providing second resources, said second resources including a plurality of storage areas for storing data accessed by the host computers;
creating a first logical partition having a first identifier in said information system, said first logical partition including a first portion of said first resources of said storage and a first portion of said second resources of said storage systems;
changing a configuration of said information system such that at least one of said first resources or said second resources is affected by the change in the configuration; and
assigning additional first resources or second resources, respectively, to said first logical partition when said first portion of said first resources or said first portion of said second resources is affected by the change in the configuration.

20. The method according to claim 19, further including steps of
receiving a service request at a first one of said storage computers, said service request requesting implementation of a first service to be carried out in said first partition;
determining whether sufficient first and second resources are available in the information system for implementation of the first service; and
assigning additional first and second resources to said first partition for implementation of the first service when sufficient first and second resources are available in the information system.
